(19) United States
(12) Patent Application Publication
(10) Pub. No.: US 2015/0000936 A1
(43) Pub. Date: Jan. 1, 2015

(54) ENERGIZATION OF AN ELEMENT WITH A THERMALLY EXPANDABLE MATERIAL

(71) Applicant: SCHLUMBERGER TECHNOLOGY CORPORATION, Sugar Land, TX (US)

(72) Inventors: Vi Nguy, Shanghai (CN); Nathan Kathol, Chestermere (CA); Craig Skeates, Calgary (CA)

(21) Appl. No.: 14/365,456

(22) PCT Filed: Dec. 11, 2012
(86) PCT No.: PCT/US12/68934

§ 371 Date: Jun. 13, 2014

Related U.S. Application Data
(60) Provisional application No. 61/570,155, filed on Dec. 13, 2011.

(51) Int. Cl. E21B 33/128; E21B 33/12; F03G 7/06

(52) U.S. Cl. CPC E21B 33/128; F03G 7/06; E21B 33/1208
USPC 166/387; 60/527; 166/179; 277/338

(57) ABSTRACT

A system and method facilitates actuation of an energized device, such as a packer. The technique provides an actuating force with a thermally expandable material located in a container. The thermally expandable material is operatively coupled with an element, such as a packer sealing element, via an actuator member. When the container and the thermally expandable material are positioned in a high heat environment, the thermally expandable material expands and actuates the element via the actuator member. In packer applications, the thermally expandable material may be used to continuously energize the packer sealing element and/or other components while the thermally expandable material is positioned in the high heat environment.

### BACKGROUND

Wells used in steam assisted gravity drainage (SAGD) and cyclic steam applications are subjected to heating of their wellbores for an extended period of time with heated fluid and/or steam, In many of these thermal wells, a liner top packer is deployed and set during the final completion of the well, The liner top packer is deployed to a specific depth with a tubing string. Once at the specific depth, the liner top packer is set by pressurizing fluid within the tubing string to a specific value. A system in the packer or in a separate setting tool translates the fluid pressure into an axial force and axial movement which energizes the packer sealing element and the packer slips (if the packer design includes slips). Due to the nature of thermal wells, the wellbore and liner top packer can experience several severe temperature and pressure fluctuations which can degrade the pressure integral seal of the packer sealing element. For example, the heating and cooling of the packer sealing element can relax the internal. stresses that were created during setting of the packer sealing element thus creating a compromised seal element which no longer maintains the pressure integral seal.

### SUMMARY

In general, the present disclosure provides for a system and method of actuating an energized device, such as a packer. The technique provides an actuating force with a thermally expandable material located in a container. The thermally expandable material is operatively coupled with an element, such as a packer sealing element, via an actuator member. When the container and the thermally expandable material are positioned in a high heat environment, the thermally expandable material expands and actuates the element via the actuator member. In packer applications, the thermally expandable material may be used to continuously energize the packer sealing element and/or other components while the thermally expandable material. is positioned in the high heat environment.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of a well system utilizing a packer actuated by a thermally expandable material, according to an embodiment of the disclosure;

FIG. 2 is a diagram illustrating an example in which thermally expandable material is used to actuate an energized device, according to an embodiment of the disclosure;

FIG. 3 is a schematic illustration of an energized device in the form of a packer, according to an embodiment of the disclosure;

FIG. 4 is a schematic illustration similar to that of FIG. 3 but showing the packer in a different operational configuration, according to an embodiment of the disclosure;

FIG. 5 is a diagram illustrating another example in which thermally expandable material is used to actuate an energized device, according to an embodiment of the disclosure;

FIG. 6 is a schematic illustration of another energized device in the form of a packer, according to an embodiment of the disclosure;

FIG. 7 is a schematic illustration similar to that of FIG. 6 but showing the packer in a different operational configuration, according to an embodiment of the disclosure; and

FIG. 8 is a schematic illustration similar to that of FIG. 6 but showing the packer in a different operational configuration, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and method for actuating an energized device, such as a packer. The technique utilizes a thermally expandable material enclosed in a container such that heat added to the material causes an increase in pressure within the container and an expansion of the material. Expansion of the thermally expandable material can be used to perform designated operations. For example, the thermally expandable material may be operatively coupled with an element, such as a packer sealing element, via an actuator member. When the container and the thermally expandable material are positioned in a high heat environment, e.g. a thermal well environment, the thermally expandable material expands and actuates the element via the actuator member. In packer applications, the thermally expandable material may be used to continuously energize the packer sealing element and/or other components while the thermally expandable material is positioned in the high heat environment.

In a variety of packer applications, energizing a packer sealing element involves compressing (squeezing) the sealing element with an axial setting force which extrudes the sealing element radially outward until it contacts a surrounding wall, e.g. a surrounding casing wall. Energizing the packer sealing element creates substantial internal stresses in the sealing element via the compressive force. The compressive force translates into large contact stresses at the boundaries of the sealing element and cooperating components, e.g. at the inside surface of the surrounding well casing and the outside surface of the packer mandrel. A correlation exists between the amount of contact stress at these boundaries and the pressure integrity of the seal. The thermally expandable material can be used to ensure that a sufficient amount of setting force (stress) is contained in the sealing element and that the pressure integral seal established by the sealing element is maintained. In some applications, an additional locking mechanism, such as a body lock ring/ratchet can be used to maintain the setting force and hold the axial travel of the packer sealing element.

Depending on the specific application, the thermally expandable material may be used in liner top packers employed in thermal wells and other well applications. In at least some of these applications, once the liner top packer has been set, the tubing string may be disengaged from the set liner top packer. The tubing string is then removed from the wellbore while the set liner top packer remains downhole in the wellbore.

The thermally expandable material may be employed in a variety of thermal well applications to facilitate actuation of energized devices, such as packers. An example of a lifecycle for a thermal well may comprise four stages including warm-up, injection, production, and shut-in. Throughout the life of a thermal well, the four stages can repeat themselves multiple times, and at each of the stages there is an associated maximum temperature and pressure experienced by the liner top packer, During certain stages, such as the injection and production stages, the liner top packer can experience the highest temperatures and pressures of the cycle.

By utilizing the thermally expandable material to actuate the liner top packer or other type of packer, dependable actuation and/or maintenance of the actuating force on the packer seal element may be maintained throughout the temperature and pressure changes that occur during the thermal well stages. According to an embodiment, a volume of the thermally expandable material is incorporated into a packer piston system or setting mechanism to initially energize/actuate the packer and/or to continuously energize the packer sealing element. The thermally expandable material enables conversion of thermal energy present in the wellbore environment into kinetic energy in a controllable and predictable manner without intervention from the surface. The kinetic energy may also be utilized to actuate various other devices and mechanisms downhole in a wellbore without any intervention from the surface. Examples of actuating such devices and mechanisms include engaging and/or disengaging packer slips, locking and/or unlocking various mechanisms, opening and/or closing ports, energizing seals, rupturing a pressure integral membrane, and actuation of various other devices.

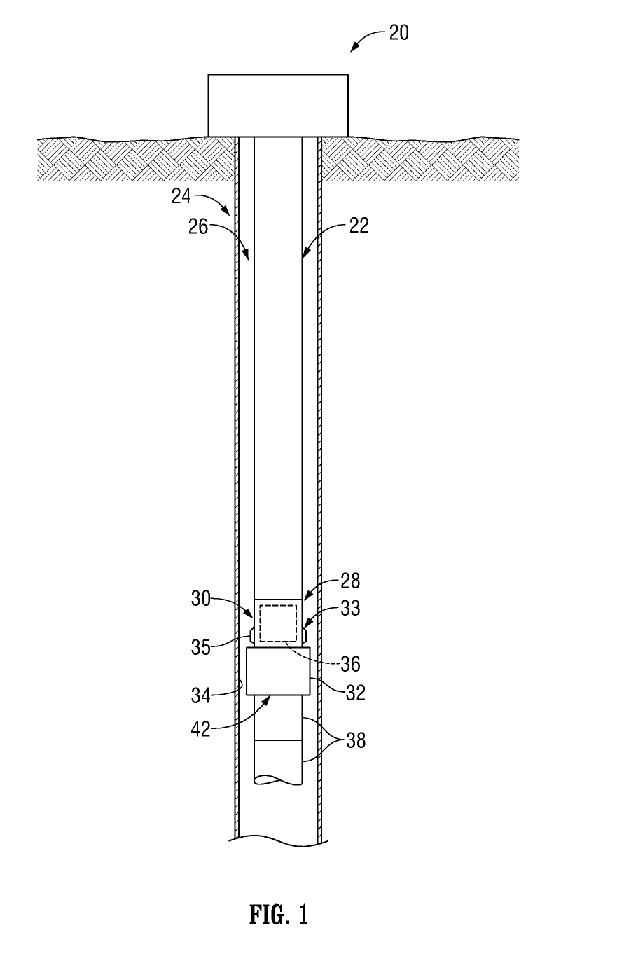

Referring generally to FIG. 1, an embodiment of a well system is illustrated. By way of example, the well system may comprise a variety of components and may be employed in many types of applications and environments, including thermal well applications, such as steam assisted gravity drainage applications and cyclic steam applications. The well system is illustrated as comprising a packer actuated by thermally expandable material. However, the well system may incorporate single or multiple packers of a variety of designs and constructions. Additionally, the well system may comprise a variety of additional components and systems depending on the specific well related application.

In the example of FIG. 1, a well system 20 is illustrated as having a tubing string 22 deployed in a well 24 comprising a wellbore 26. In at least some applications, the well 24 comprises a thermal well, such as a thermal well employed in a steam assisted gravity drainage application or a cyclic steam application that involves heating of the wellbore or wellbores 26 for an extended period of time with heated fluid or steam. The illustrated tubing string comprises an energized device system 2$ having an energized device 30, e.g. a packer, comprising an energized member 32. The energized device/packer 30 may comprise a liner top packer or other type of packer having energized member 32 in the form of a radially expandable packer sealing element acted on by an actuator 33. The actuator 33 radially expands the sealing element 32 into sealing engagement with a surrounding wellbore wall 34, e.g. a casing wall. The actuator 33 also may be used to actuate additional energized members or parts of the energized member 32, such as packer slips 35. In this example, the actuator 33 comprises, or works in cooperation with, a thermally expandable material 36 which may be used to provide the actuating force. It should be noted that tubing string 22 may also comprise a variety of other components 38 and those components may vary depending on the specific environment and/or application in which tubing string 22 is deployed. Depending on the specific application, the tubing string 22 may be deployed in many types of wells, including horizontal or otherwise deviated wells and also vertical wells.

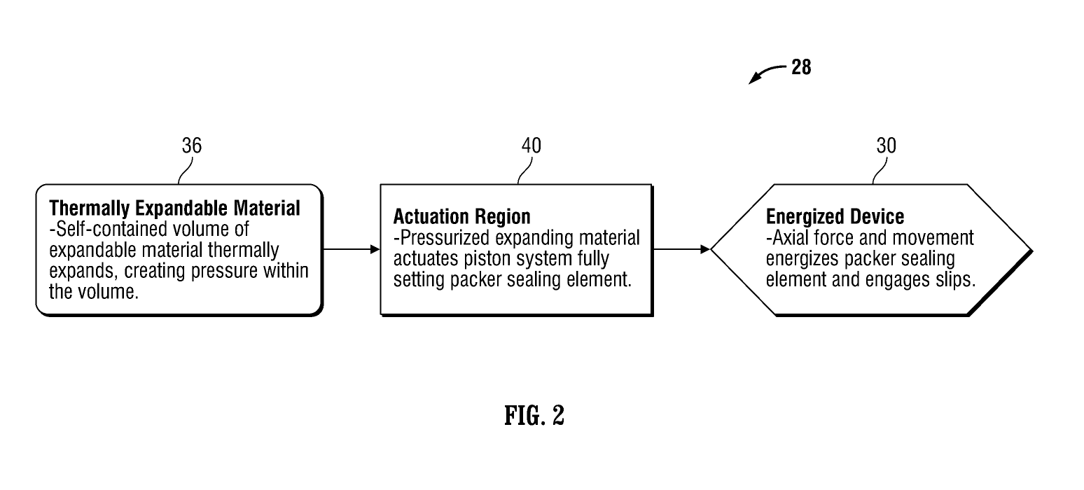

Referring generally to FIG. 2, a diagram is provided to illustrate an example of energized device system 28. In this example, the energized device system 28 comprises cooperating elements including the energized device 30. The energized device 30 may be used to apply a specific force, such as an axial force, that actuates the sealing element 32. In some applications, the energized device 30 comprises a packer and the applied axial force is used to energize the packer sealing element 32 and/or to engage the packer slips 35. In this example, another element of the energized device system 28 is an actuation region 40 which works in cooperation with thermally expandable material 36. Actuation region 40 may comprise a variety of actuation members, including a piston or pistons acted on by the pressure of expanding material 36 to fully set the energized device/packer 30, e.g. to expand the packer sealing element 32 into engagement with a surrounding wellbore wall 34 and/or to engage the packer slips 35. In this example, the thermally expandable material 36 is in a self-contained volume so that during thermal expansion of material 36, pressure is created within the self-contained volume. This pressure is used to move the piston or other actuator member when actuating the energized device 30.

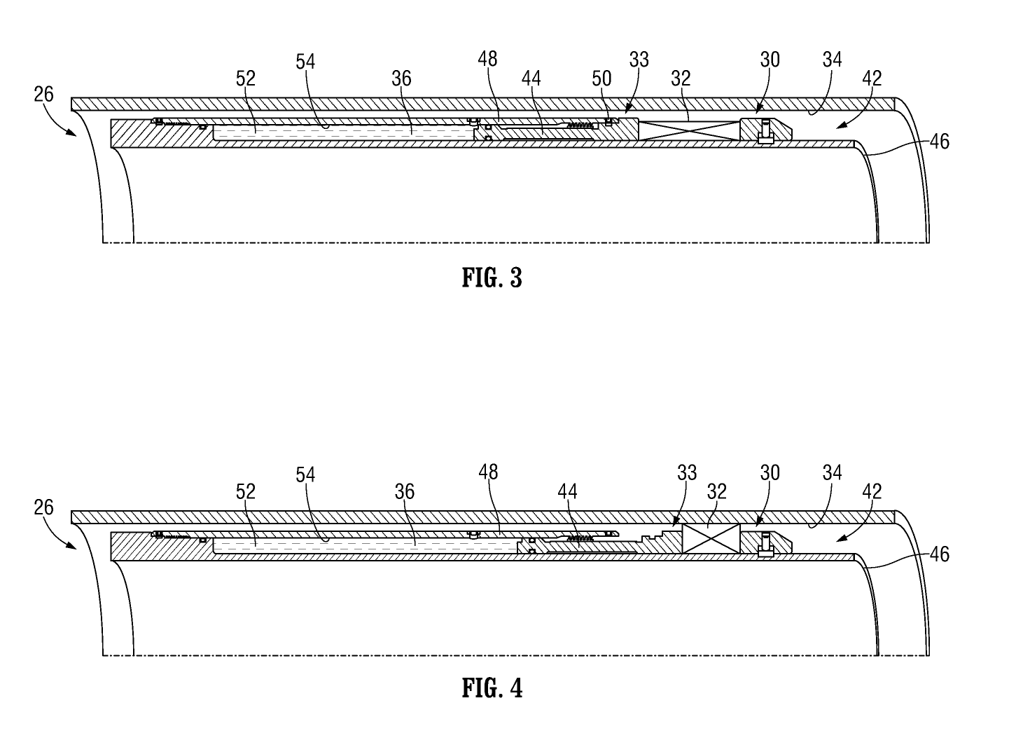

Referring generally to FIGS. 3 and 4, an example of energized device 30 is illustrated. In this example, the energized device 30 comprises a radially expandable packer 42 (see also FIG. 1) having sealing element 32 which may be axially compressed to cause radial expansion of the sealing element 32 into sealing engagement with the surrounding wellbore wall 34. The force to cause axial compression of sealing element 32 may be applied by actuator 33 in the form of an actuator member 44, such as a piston or pistons slidably mounted between an inner tubing/mandrel 46 and an external housing 48. By way of example, actuator member/piston 44 may comprise an annular piston surrounding the inner tubing 46 within the external housing 48. Prior to energizing packer sealing element 32, piston 44 may be secured to external housing 48 by a shear member 50.

The piston 44 is moved in an axial direction by the thermally expandable material 36 disposed in a self-contained volume 52 defined by a container 54. In the example illustrated, the container 54 is created by inner tubing 46 and external housing 48 which are constructed to create the self-contained volume 52 therebetween. The self-contained or confined volume 52 may be annular in shape and may extend around the circumference of inner tubing 46. At one end of the self-contained volume 52, piston 44 is exposed to the thermally expandable material 36. When exposed to sufficient heat, such as the heat experienced in a thermal well application, thermally expandable material 36 expands and builds up sufficient pressure within container 54 to shear the shear member 50 and release piston 44. Continued expansion of the thermally expandable material 36 causes movement of piston 44 which transitions the packer sealing element 32 from the de-energized state illustrated in FIG. 3 to the energized state illustrated in FIG. 4. In other words, the movement of piston 44 by thermally expandable material 36 causes axial compression of packer sealing element 32 which results in a radial expansion of sealing element 32 into sealing engagement with the surrounding wellbore wall 34, as illustrated in FIG. 4.

The thermally expandable material 36 is selected to have a higher thermal expansion value, e.g., a higher coefficient of thermal expansion, than that of the material forming container 54. In the example illustrated, the thermally expandable material 36 is contained in volume 52 and pressure sealed. The actuator 33 translates the pressure generated by the thermally expandable material 36 into an axial force and axial movement of, for example, piston 44. It should be noted that the force and movement resulting from the expansion of thermally expandable material 36 can be used to actuate various devices and mechanisms, including various devices and mechanisms in the packer 42. As described above, the thermally expandable material 36 may be used to actuate/energize both the sealing element 32 and the slips 35 (see FIG. 1).

By way of example, the thermally expandable material 36 may be in the form of a liquid with a high thermal expansion coefficient and a low bulk modulus value. Additionally, the liquid may be thermally stable in that the liquid does not degrade at elevated temperatures and the liquid does not react violently, e.g. explode, at elevated temperatures. Examples of thermally expandable material 36 include dimethyl polysiloxane, commercially available from Dow Chemical Company of Midland, Mich., USA under the trade name Syltherm 800™, and DI-2 ethylhexyl sebacate, commercially available from The HallStar Company of Chicago, Ill., USA under the trade name Monoplex DOS™.

During heating of the liquid/thermally expandable material 36, the density of the liquid begins to decrease as the liquid expands. Because the density is decreasing and the thermally expandable material 36 is confined in the self-contained volume 52 of container 54, pressure builds within container 54. The pressurized, thermally expandable material 36 acts on piston 44 and drives piston 44 into packer sealing element 32 to axially compress the element. As long as the thermally expandable material 36 remains heated, the self-contained volume 52 remains pressurized to continuously energize the packer sealing element 32 and/or other energized elements. When the thermally expandable material 36 begins to cool, the material increases in density and reduces the pressure within container 54. As a result, the energized element, e.g. sealing element 32, is de-energized. (In some applications, however, a locking element may be used to retain the packer sealing element 32 and/or other elements in the set configuration. For example, a locking body may be located in piston traps to retain the setting force in the energized element, e.g. sealing element 32.) Effectively, the thermally expandable material enables the energized device 30 to be initially energized and then continuously maintained in that state of energization while the thermally expandable material 36 is exposed to sufficient heat. The process of energizing the packer or other element can be accomplished without an additional intervention process from the surface.

It should be noted that thermally expandable material 36 is readily usable in thermal well applications due to the normal heating of such wells during recovery of hydrocarbons. In various thermal well applications, the wellbore temperature and pressure can vary greatly over the life of a well, however such fluctuations have limited detrimental effects on the packer 42 which incorporates the thermally expandable material 36 to continuously energize the packer sealing element 32. The thermally expandable material 36 is able to utilize the available elevated temperature in the wellbore during the injection and production stages of a thermal well application to assist in creating a more robust pressure integral seal for withstanding the higher pressure present during these stages.

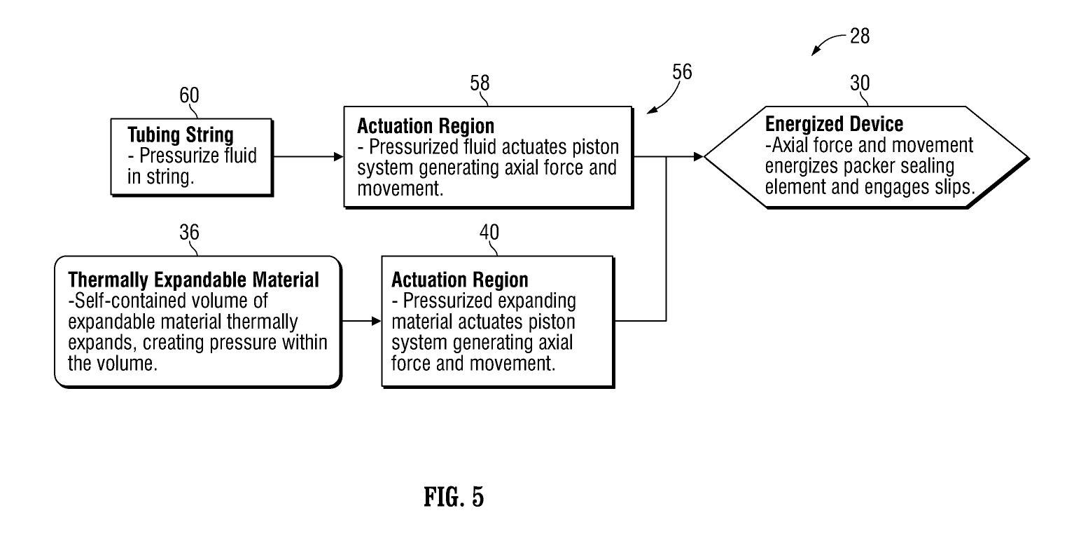

Referring generally to FIG. 5, a diagram is provided to illustrate another example of energized device system 28. In this example, the energized device system 28 again comprises cooperating elements including the energized device 30. As with the embodiment illustrated in FIG. 2, the energized device 30 may be used to apply a specific force, such as an axial force, that actuates the device, e.g. actuates a packer sealing element 32. For example, the energized device 30 may comprise packer 42 and the applied axial force may be used to energize the packer sealing element 32 and/or to engage the packer slips 35. In this example, the energized device system 28 similarly comprises actuation region 40 which works in cooperation with thermally expandable material 36. Actuation region 40 may comprise a variety of actuator members 44, including a piston or pistons acted on by the pressure of expandable material 36 to fully set packer 30, e.g. to expand the packer sealing element 32 into engagement with a surrounding wall 34 and/or to engage the packer slips 35. In this example, the thermally expandable material 36 is in the self-contained volume 52.

However, the energized device system 28 also comprises a supplemental actuation system 56 which works in cooperation with the thermally expandable material 36. By way of example, the supplemental actuation system 56 comprises a supplemental actuator/actuation region 58. The supplemental actuator 58 utilizes a supplemental force generating mechanism, such as pressurized fluid acting against a supplemental pressure piston to generate a complementary axial force and movement. By way of example, the supplemental force generating mechanism may comprise a tubing string 60 which delivers pressurized fluid to the supplemental pressure piston in a manner which provides additional axial force in combination with the axial force provided by the thermally expandable material 36. In packer applications, the pressurized fluid may be delivered through tubing string 22 or through an annulus surrounding tubing string 22. In some applications, thermally expandable material 36 is utilized as a setting or energizing booster in addition to providing a mechanism for continuously energizing packer sealing element 32.

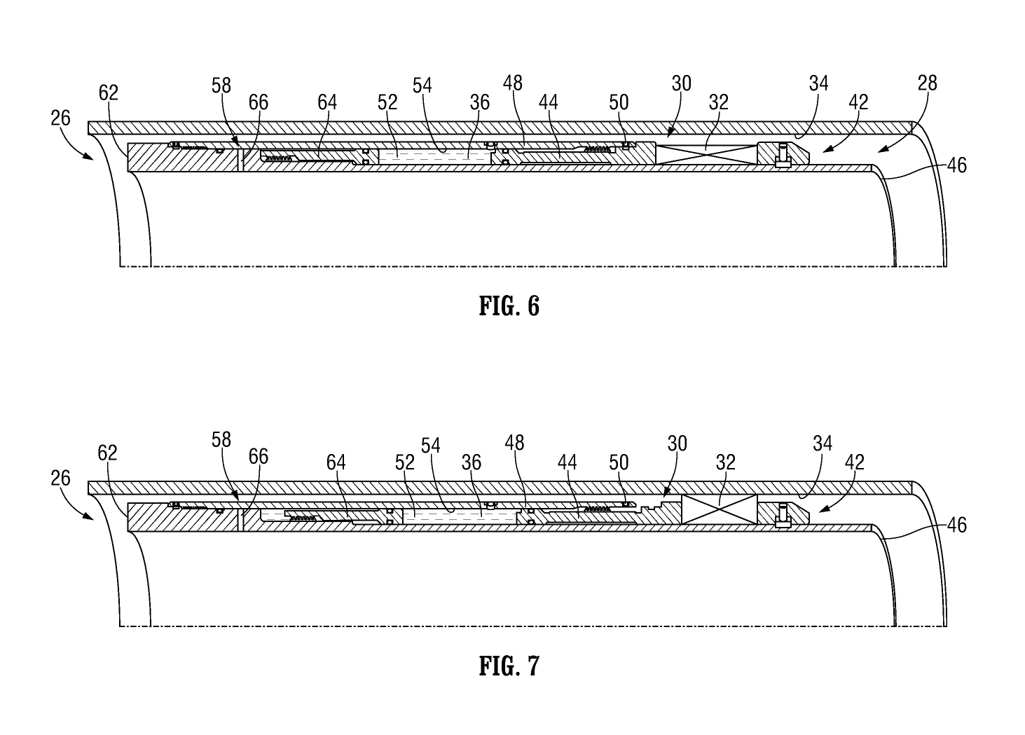

Referring generally to FIGS. 6, 7 and 8, an example of energized device 30 is illustrated in which the thermally expandable material 36 is combined with a supplemental actuator or serves as a supplemental actuator. In this example, the energized device 30 again comprises radially expandable packer 42 having sealing element 32 which may be axially compressed to cause radial expansion of the sealing element 32 into sealing engagement with the surrounding wellbore wall 34. The force to cause axial compression of sealing element 32 may be applied via both tubing pressure and the force exerted by thermally expandable material 36 when exposed to sufficient heat in the well environment.

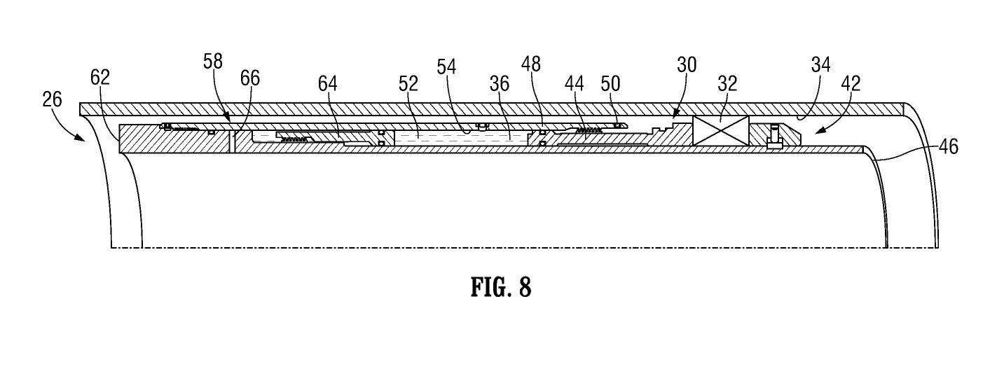

During movement of the energized device system 28 into wellbore 26, the packer sealing element 32 is in a de-energized or radially contracted state, as illustrated in FIG. 6. Once at a desired location within wellbore 2.6, pressurized fluid is delivered downhole through tubing 62 of tubing string 22 to partially set the packer sealing element 32 and/or slips 35 (see FIG. 1). The pressurized fluid is delivered to a pressure piston or pistons 64, e.g. an annular piston, via a port 66. The pressurized fluid acts on piston 64 and causes shearing of shear member 50 before shifting the pressure piston 64 and initiating compression of packer sealing element 32, as illustrated in FIG. 7. Additionally, the heat of the wellbore environment or heat added to the wellbore environment causes expansion of thermally expandable material 36 within the self-contained volume 52 of container 54. With sufficient heating, the thermally expandable material 36 expands to drive piston 44 in an axial direction, as illustrated in FIG. 8. The axial movement of piston 44 further compresses sealing element 32 so as to form a dependable seal with the surrounding wellbore wall 34. The thermally expandable material 36 may also be used to maintain the dependable seal while exposed to the high heat environment. Depending on the application, the expansion of thermally expandable material 36 may also be employed to set and/or maintain the setting of other components.

The thermally expandable material 36 may be utilized in a variety of applications and in many types of environments. Additionally, the energized device system 28 employing the thermally expandable material 36 may be used to supplement or replace other technologies. For example, the energized device system 28 may be used to replace swellable element technologies in certain environments, such as environments in which temperature and pressure are at the upper limits of or beyond the capabilities of swellable element materials. Similar to a swellable element, the thermally expandable material is able to fully energize the sealing element to create a pressure integral seal without any intervention from the surface. Unlike swellable elements, however, the thermally expandable material 36 serves as a setting mechanism independent of the packer sealing element 32. The combination of thermally expandable material 36 with a high temperature, high pressure sealing element, e.g. a suitable packer sealing element, can be used to provide the functionality of a swellable element but with a substantially increased service life at high temperatures and pressures.

The thermally expandable material 36 and the energized device system 28 may be employed in many high temperature and high pressure applications, including high temperature injector well applications. In certain high temperature injector well applications, a series of packer elements is utilized to segment the well and to improve fluid placement via the injector well. The energized device system 28 may be used in individual or multiple packers deployed in several types of thermal well applications, including steam assisted gravity drainage applications and cyclic steam applications. The thermally expandable material 36 may also be used to actuate other or additional components of packer 42. In some applications, the thermally expandable material 36 may be used in energizing/actuating various other components along the tubing string 22.

Depending on the material and/or environment in which the energized device 30 is employed, the device may have many forms and configurations. The energized device may also utilize various materials and material configurations. In certain embodiments, the thermally expandable material is used singularly to energize a device, while other applications utilize the thermally expandable material as a cooperating or supplemental actuation mechanism. The thermally expandable material may be deployed in individual containers or in a plurality of containers that work in cooperation or serve to actuate different components. Additionally, the thermally expandable material may be in liquid form or other forms and may comprise various individual materials or combinations of materials depending on the parameters of a given application.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for use in a well, comprising:
a packer having a packer sealing element; and
an actuator to transition the packer sealing element into sealing engagement with a surrounding wall, the actuator comprising:
a piston exposed to a confined volume; and
a thermally expandable material disposed in the confined volume such that increased temperature causes the thermally expandable material to increase pressure during expansion within the confined volume, thus moving the piston; transitioning the packer sealing element into sealing engagement with the surrounding wall; and continuously energizing the packer sealing element while the thermally expandable material is exposed to the increased temperature.

2. The system of claim 1, wherein the packer further comprises a plurality of slips operated by the actuator upon expansion of the thermally expandable material.

3. The system of claim 1, wherein the actuator further comprises a pressure piston moved by a pressurized fluid supplied to the actuator via tubing, the pressure piston working in cooperation with the piston to transition the packer sealing element into sealing engagement with the surrounding wall.

4. The system of claim 1, wherein the thermally expandable material is thermally stable in high temperature thermal well environments.

5. The system of claim 1, wherein the thermally expandable material comprises dimethyl polysiloxane.

6. The system of claim 1, wherein the thermally expandable material comprises DI-2 ethylhexyl sebacate.

7. The system of claim 1, wherein the confined volume is located in a container formed of material having a coefficient of thermal expansion less than that of the thermally expandable material.

8. The system of claim 7, wherein the confined volume is annular in shape.

9. A system for actuation of a device, comprising:
an energized member actuatable between an unsealed configuration and a sealed configuration;
a thermally expandable material located in a container; and
an actuator member operatively linking the energized member and the thermally expandable material such that an increase in temperature of the thermally expandable material causes the actuator member to transition the energized member to the sealed configuration.

10. The system of claim 9, wherein the energized member comprises a packer sealing element.

11. The system of claim 10, wherein the energized member further comprises a plurality of slips.

12. The system of claim 9, wherein the actuator member comprises a piston.

13. The system of claim 9, wherein the actuator member comprises an annular piston positioned around a tubing extending through a packer.

14. The system of claim 9, wherein the container is formed of material having a coefficient of thermal expansion less than that of the thermally expandable material.

15. The system of claim 9, wherein the thermally expandable material comprises dimethyl polysiloxane.

16. The system of claim 9, wherein the thermally expandable material comprises DI-2 ethylhexyl sebacate.

17. The system of claim 9, further comprising a supplemental actuator which works in cooperation with the thermally expandable material.

18. A method of actuation, comprising:
providing a thermally expandable material in a container;
operatively coupling the thermally expandable material with a packer sealing element via an actuator member;
positioning the container and the thermally expandable material downhole in a high heat environment so that the thermally expandable material expands and actuates the packer sealing element; and
continuously energizing the packer sealing element via the thermally expandable material while the thermally expandable material is positioned in the high heat environment.

19. The method of claim 18, wherein operatively coupling the thermally expandable material with a packer sealing element via an actuator member comprises enabling the thermally expandable material to act against the actuator member which is in the form of a piston energizing the packer sealing element.

20. The method of claim 18, further comprising supplementing the force applied by the thermally expandable material with additional force applied via tubing pressure.
